(19) United States
(12) Patent Application Publication
(10) Pub. No.: US 2023/0378460 A1
(43) Pub. Date: Nov. 23, 2023

(54) CATHODE FOR LITHIUM SECONDARY BATTERY, LITHIUM SECONDARY BATTERY AND METHOD OF PREPARING CATHODE ACTIVE MATERIAL FOR LITHIUM SECONDARY BATTERY

(71) Applicants: SK ON CO., LTD., Seoul (KR); SK INNOVATION CO., LTD., Seoul (KR)

(72) Inventors: Sang Han LEE, Daejeon (KR); Ju Wook LEE, Daejeon (KR); Jong Hyuk LEE, Daejeon (KR); Jung Hwan KIM, Daejeon (KR); Soo Min PARK, Daejeon (KR); In Haeng CHO, Daejeon (KR); Dong Wook HA, Daejeon (KR)

(21) Appl. No.: 18/319,486

(22) Filed: May 18, 2023

(30) Foreign Application Priority Data
May 18, 2022 (KR) 10-2022-0060812

(51) Int. Cl. H01M 4/525; H01M 10/052; H01M 4/04

(52) U.S. Cl. CPC H01M 4/525; H01M 10/052; H01M 4/0471; H01M 2004/021

(57) ABSTRACT

A cathode for a lithium secondary battery includes a cathode current collector, and a cathode active material layer satisfying a specific formula formed on the cathode current collector. The cathode active material layer includes lithium metal oxide particles that have a single particle shape, and a single crystalline structure or a poly-crystalline structure including two or more single crystals. A lithium secondary battery including the cathode, and a method of preparing a cathode active material are also provided.

### CROSS-REFERENCE TO RELATED APPLICATION AND CLAIM OF PRIORITY

This application claims priority to Korean Patent Applications No. 10-2022-0060812 filed on May 18, 2022 in the Korean Intellectual Property Office (KIPO), the entire disclosure of which is incorporated by reference herein.

### BACKGROUND

### 1. Field

The present invention relates to a cathode for a lithium secondary battery, a lithium secondary battery and a method of preparing a cathode active material for a lithium secondary battery.

### 2. Description of the Related Art

A secondary battery which can be charged and discharged repeatedly has been widely employed as a power source of an electric vehicle, a mobile electronic device such as a camcorder, a mobile phone, a laptop computer, etc.

A lithium secondary battery is actively developed and employed due to high operational voltage and energy density per unit weight, a high charging rate, a compact dimension, etc.

For example, the lithium secondary battery may include an electrode assembly including a cathode, an anode and a separation layer interposed between the cathode and the anode, and an electrolyte solution immersing the electrode assembly.

For example, the cathode may include a cathode current collector and a cathode active material layer formed on the cathode current collector. The cathode active material layer may include lithium metal oxide particles as a cathode active material.

The lithium metal oxide particles generally have a secondary particle shape in which a plurality of primary particles are aggregated in a morphological aspect, and the primary particles generally have a polycrystalline structure in a crystallographic aspect.

However, cracks may occur in the lithium metal oxide particles having the secondary particle shape and the polycrystalline structure during a pressing process in a cathode manufacturing process. Additionally, cracks may occur in the particles due to intercalation and deintercalation of lithium during repetitive charging and discharging of the lithium secondary battery.

Accordingly, generation of gas due to a side reaction between the lithium metal oxide particles and the electrolyte solution may be caused, and life-span properties of the lithium secondary battery may be deteriorated. The above issues may be accelerated in high-temperature environment.

In disclosures of Korean Published Patent Publication No. 10-2021-0119905, nickel-cobalt-based lithium metal oxide particles having a single particle shape are employed to improve life-span properties of a lithium secondary battery.

### SUMMARY

According to an aspect of the present invention, there is provided a cathode for a lithium secondary battery having improved mechanical and chemical stability.

According to an aspect of the present invention, there is provided a lithium secondary battery having improved mechanical and chemical stability.

According to an aspect of the present invention, there is provided a method of preparing a cathode active material for a lithium secondary battery having improved mechanical and chemical stability.

A cathode for a lithium secondary battery includes a cathode current collector and a cathode active material layer formed on the cathode current collector. The cathode active material layer includes lithium metal oxide particles that have a single particle shape, and a single crystalline structure or a poly-crystalline structure including two or more single crystals. The cathode active material layer satisfies Formula 1.

1 μm≤S/N≤3 μm [Formula 1]

In Formula 1, N is a total number of single crystals in which at least one of a major axis length and a minor axis length is 0.3 μm or more in a focused ion beam (FIB) analysis image of the cathode active material layer. S is a total sum of crystal sizes of the single crystals in which at least one of the major axis length and the minor axis length is 0.3 μm or more measured from the FIB analysis image, and the crystal size of the single crystal means an average value of the major axis length and the minor axis length measured from the FIB analysis image.

In some embodiments, 1 μm≤S/N≤2 μm.

In some embodiments, in the FIB analysis image, a ratio of a total cross-sectional area of the single crystals in which at least one of the major axis length and the minor axis length is 0.3 μm or more relative to a total cross-sectional area of the lithium metal oxide particles may be 0.5 or more.

In some embodiments, the lithium metal oxide particles may include first lithium metal oxide particles having a shape of a single particle and a poly-crystalline structure, and second lithium metal oxide particles having a shape of a single particle and a single crystalline structure.

In some embodiments, in the FIB analysis image, a ratio of the number of the second lithium metal oxide particles relative to the number of the first lithium metal oxide particles is in a range from 0.1 to 10.

In some embodiments, the lithium metal oxide particles may satisfy Formula 2.

9.8%≥100×I(110)/{I(110)+I(003)} [Formula 2]

In Formula 2, I(110) is a maximum height of a (110) plane peak in an X-ray diffraction (XRD) analysis spectrum measured for the lithium metal oxide particles, and I(003) is a maximum height of a (003) plane peak in the XRD analysis spectrum.

In some embodiments, the lithium metal oxide particles may contain nickel (Ni).

In some embodiments, the cathode for a lithium secondary battery may satisfy Formula 3.

C≥140+0.738×Ni_{c} [Formula 3]

In Formula 3, C is a numerical value of a discharge capacity expressed in a unit of mAh/g measured by charging under constant current and constant voltage conditions of 0.1C 4.3V 0.05C CUT-OFF, and discharging under conditions of 0.1C 3V CUT-OFF of a half-cell having a lithium counter electrode, and Ni_{c} is a numerical value of mol % of nickel relative to a total number of moles of all elements except lithium and oxygen in the lithium metal oxide particles.

A lithium secondary battery includes the cathode for a lithium secondary battery according to the above-described embodiments, and an anode facing the cathode.

In a method of preparing a cathode active material for a lithium secondary battery, a mixture of metal hydroxide particles and a lithium source is prepared. A first calcination of the mixture is performed at a first temperature. A second calcination of a product from the first calcination is performed at a second temperature lower than the first temperature.

In some embodiments, the first calcination and the second calcination may each be performed for 1 hour to 10 hours.

In some embodiments, the first temperature may be in a range from 900° C. to 1000° C.

In some embodiments, the second temperature may be in a range from 600° C. to 800° C.

In some embodiments, the first calcination and the second calcination may be performed alternately and repeatedly.

In some embodiments, when performing the first calcination and the second calcination once each is defined as a calcination cycle, at least two of the calcination cycles are performed.

A cathode for a lithium secondary battery according to exemplary embodiments includes a cathode active material layer including a cathode active material that includes lithium metal oxide particles having a predetermined shape/crystal structure, and satisfying Formula 1. Accordingly, a lithium secondary battery having high-capacity and high-power properties, improved life-span propertied and high-temperature stability may be provided.

### BRIEF DESCRIPTION OF THE DRAWINGS

FIG. 1 is a schematic cross-sectional view of a cathode for a lithium secondary battery in accordance with exemplary embodiments.

FIG. 2 is a flow diagram schematically describing a method of preparing a cathode active material for a lithium secondary battery in accordance with exemplary embodiments.

FIGS. 3 and 4 are a schematic plan projection view and a cross-sectional view, respectively, illustrating a lithium secondary battery in accordance with exemplary embodiments.

FIG. 5 is an image obtained by analyzing a cross-section of a cathode according to Example 1 using a focused ion beam (FIB).

### DETAILED DESCRIPTION OF THE EMBODIMENTS

According to embodiments of the present invention, a cathode for a lithium secondary battery containing a lithium metal oxide particle having a predetermined shape and crystal structure is provided. Further, a method of preparing the cathode active material and a lithium secondary battery including the cathode are also provided.

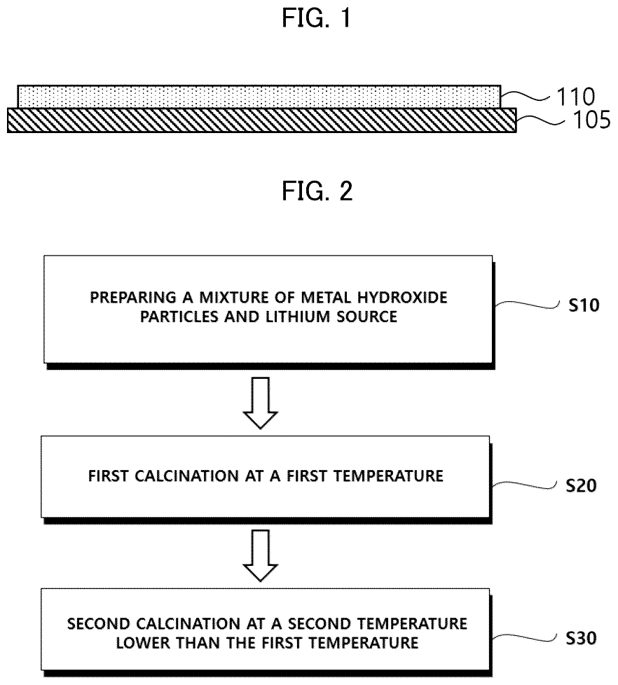

FIG. 1 is a schematic cross-sectional view of a cathode for a lithium secondary battery in accordance with exemplary embodiments.

Referring to FIG. 1, a cathode for a lithium secondary battery according to embodiments of the present invention includes a cathode current collector 105 and a cathode active material layer 110 formed on the cathode current collector 105.

For example, the cathode active material layer 110 may be formed on one surface or both surfaces of the cathode current collector 105.

The cathode active material layer 110 may include lithium metal oxide particles as a cathode active material. In some embodiments, the cathode active material layer 110 may further include a conductive material and a binder.

In exemplary embodiments, the cathode active material layer 110 may include lithium metal oxide particles having a shape of a single particle.

The single particle can be morphologically distinguished from a secondary particle. For example, the single particle and the secondary particle may be classified based on a cross-sectional image of the particle measured by a scanning electron microscope (SEM).

For example, the secondary particle may refer to a particle that is substantially considered or observed as one particle by aggregation of a plurality of primary particles. For example, a boundary of the primary particles in the case of the secondary particle can be observed by the SEM cross-sectional image.

In an embodiment, the secondary particle may be an aggregate of more than 10, 30, 50, or 100 primary particles.

For example, the single particle may refer to a monolith rather than the aggregate. For example, in the case of the single particle, the boundary of the primary particles may not be observed in the SEM cross-sectional image.

Fine particles (e.g., particles having a volume of 1/100 or less of a volume of the single particle) may be attached to a surface of the single particle, and this shape is not excluded from the concept of the single particle.

For example, the single particles may exist in contact with each other. For example, 2 to 10, 2 to 5, or 2 to 3 single particles may exist in contact with each other.

In exemplary embodiments, the lithium metal oxide particles having the single particle shape may have a single crystalline structure or a poly-crystalline structure in a crystallographic aspect.

If the single particle has the single crystalline structure, the single particle may consist of one single crystal. If the single particle has the poly-crystalline structure, the single particle may include two or more single crystals.

For example, the single-crystalline structure and the poly-crystalline structure may be classified based on an ion image obtained by analyzing a cross-section of a particle by a focused ion beam (FIB). If a particle has the poly-crystalline structure, two or more single crystals may be observed in the FIB analysis image according to a difference in crystal orientation. For example, even though a particle is observed as a single particle in an SEM cross-sectional image, the particle may be observed as being formed of two or more crystals in an FIB analysis image.

When the lithium metal oxide particles having the shape of the secondary particle are used as the cathode active material, the life-span properties and high-temperature stability of the lithium secondary battery may be relatively degraded. When the lithium metal oxide particles having the shape of the single particle are used as the cathode active material, the life-span properties and high-temperature stability of the lithium secondary battery may be improved, but capacity and power properties may be relatively degraded.

According to embodiments of the present invention, an average value of a crystal size (S_{FIB}) of the single crystals measured from the FIB image of a cross-section of the cathode active material layer 110 may be adjusted in a range from 1 μm to 3 μm. Accordingly, a lithium secondary battery having high-capacity and high-power properties, improved life-span properties and high-temperature stability may be implemented.

In an embodiment, the S_{FIB} may be calculated only for single crystals having at least one of a major axis length and a minor axis length (i.e., the major axis length and/or the minor axis length) of 0.3 μm or more. For example, a single crystal having a major axis length and a minor axis length of less than 0.3 μm may be excluded from the S_{FIB} calculation. In this case, when deriving the average value, fine-sized single crystals that may greatly contribute to the average calculation may be excluded.

Accordingly, the S_{FIB} calculation may target only the single crystals that contribute more to the improvement of the life-span properties and high-temperature stability.

In some embodiments, S_{FIB} can be represented by S/N, and S/N can satisfy Formula 1.

1 μm≤S/N≤3 μm [Formula 1]

In Formula 1, N is a total number of single crystals in which at least one of a major axis length and a minor axis length is 0.3 μm or more measured from the FIB analysis image.

S is a total sum of crystal sizes of the single crystals in which at least one of the major axis length and the minor axis length is 0.3 μm or more measured from the FIB analysis image.

The crystal size of the single crystal means an average value of the length of the major axis and the length of the minor axis (i.e., as expressed in Formula 1-2 below), measured from the FIB analysis image.

Crystal size of single crystal=(major axis length of single crystal+minor axis length of single crystal)/2 [Formula 1-2]

The length of the major axis of the single crystal may mean a length of the longest line among straight lines having both end points at a circumference of the single crystal. The length of the minor axis of the single crystal may mean a length of the shortest line among straight lines having both end points at the circumference of the single crystal and intersecting a central point of the major axis of the single crystal.

For example, when the S_{FIB} is less than 1 the life-span properties and high-temperature stability of the lithium secondary battery may be deteriorated. If the S_{FIB} exceeds 3 μm, the capacity and power properties of the lithium secondary battery may be deteriorated.

In some embodiments, S_{FIB} may be in a range from 1 μm to 2.5 μm, from 1 μm to 2 μm, from 1 μm, to 1.6 μm, from 1 μm, to 1.5 μm, from 1.1 μm to 1.5 μm, or from 1.2 μm, to 1.5 μm, Within the above range, the capacity and power properties of the lithium secondary battery may be maintained at a higher level, and the life-span properties and high-temperature stability may be further improved.

S_{FIB} may be distinguished from a crystallite size (S_{XRD}) of a single crystal in the lithium metal oxide particles calculated according to an X-ray diffraction spectroscopy (XRD).

In an embodiment, the S_{XRD} value of the lithium metal oxide particles may be 200 nm or more, 250 nm or more, 300 nm or more, or 500 nm or more. Further, the S_{XRD} value may be 1,000 nm or less, 900 nm or less, or 800 nm or less.

In an embodiment, in the FIB analysis image, a ratio of a total cross-sectional area of single crystals in which at least one of the major axis length and the minor axis length is 0.3 μm or more relative to a total cross-sectional area of the lithium metal oxide particles may be 0.5 or more, preferably 0.6 or more, more preferably 0.7 or more, further preferably 0.8 or more.

In an embodiment, the lithium metal oxide particles may include first lithium metal oxide particles having the single particle shape and the polycrystalline structure.

In some embodiments, the lithium metal oxide particles may include a second lithium metal oxide particle having the single particle shape and the single crystal structure.

In some embodiments, in the FIB analysis image, a ratio of the number of the second lithium metal oxide particles relative to the number of the first lithium metal oxide particles may be in a range from 0.1 to 10, from 0.2 to 8, 0.3 to 6, or from 0.5 to 5.

In an embodiment, the lithium metal oxide particles may satisfy Formula 2. In this case, an excessive increase of a lithium diffusion path may be prevented, and the power properties of the lithium metal oxide particles may be further improved.

9.8%≥100×I(110)/{I(110)+I(003)} [Formula 2]

In Formula 2, I(110) is a maximum height of a (110) plane peak in an X-ray diffraction (XRD) analysis spectrum of the lithium metal oxide particles, and I(003) is a maximum height of a (003) plane peak in the XRD analysis spectrum.

In some embodiments, the values of 100×I(110)/{I(110)+I(003)} may be 1 or more, 2 or more, 3 or more, 4 or more, or 5 or more. Within the above range, a cation mixing phenomenon generated in the lithium metal oxide particles may be further suppressed, and capacity deterioration of the lithium secondary battery may be further prevented.

The lithium metal oxide particles may contain nickel (Ni). In some embodiments, the lithium metal oxide particles may further include cobalt (Co), manganese (Mn), aluminum (Al), etc.

In some embodiments, the lithium metal oxide particles may contain 80 mol % or more, preferably 85 mol % or more, 88 mol % or more, more preferably 90 mol % or more of nickel among all elements except lithium and oxygen.

In an embodiment, the cathode for a secondary lithium battery may satisfy Formula 3.

C≥140+0.738×Ni_{c} [Formula 3]

In Formula 3, C is a numerical value of a discharge capacity expressed in a unit of mAh/g measured by CC/CV charging (0.1C 4.3V 0.05C CUT-OFF) and discharging (0.1C 3V CUT-OFF) of a half-cell having a lithium counter electrode. Ni_{c} is a numerical value of mol % of nickel relative to the total number of moles of all elements except lithium and oxygen in the lithium metal oxide particles.

In some embodiments, C≥150+0.738×Ni_{c}, or C≥155+0.738×Ni_{c}.

In some embodiments, the lithium metal oxide particles may be represented by

Chemical Formula 1.

LiₓNi(1-a-b)M1ₐM2_{b}O_{y} [Chemical Formula 1]

In Chemical Formula 1, M1 and M2 may each include at least one of Co, Mn, Al, Zr, Ti, Cr, B, Mn, Ba, Si, Y, W and Sr, 0.9≤x≤1.2, 1.9≤y≤2.1, and 0≤a+b≤0.2.

In some embodiments, 0<a+b≤0.15, preferably 0<a+b≤0.12, more preferably 0<a+b≤0.1.

In an embodiment, the lithium metal oxide particles may further contain a doping element. For example, the doping element may include Al, Ti, Ba, Zr, Si, B, Mg, P, Sr, W, La, etc.

In an embodiment, the cathode active material may further include a coating layer formed on at least a portion of a surface of the lithium metal oxide particle. For example, the coating layer may contain Al, Ti, Ba, Zr, Si, B, Mg, P, Sr, W, La, etc.

In an embodiment, the cathode active material layer 110 may further include third lithium metal oxide particles having a shape of a secondary particle under a condition where Formula 1 is satisfied.

In some embodiments, a content of the single particle-shaped lithium metal oxide particles may be 50 weight percent (wt %) or more, 60 wt % or more, 70 wt % or more, or 80 wt % or more based on a total weight of the cathode active material layer 110.

In one embodiment, the cathode current collector 105 may include stainless steel, nickel, aluminum, titanium, copper, or an alloy thereof.

The cathode binder may include an organic based binder such as polyvinylidenefluoride (PVDF), a polyvinylidene fluoride-hexafluoropropylene copolymer (PVDF-co-HFP), polyacrylonitrile, polymethylmethacrylate, etc., or an aqueous based binder such as styrene-butadiene rubber (SBR) that may be used with a thickener such as carboxymethyl cellulose (CMC).

The conductive material may include a carbon-based material such as graphite, carbon black, graphene, carbon nanotube, etc., and/or a metal-based material such as tin, tin oxide, titanium oxide, a perovskite material such as LaSrCoO₃ or LaSrMnO₃, etc.

FIG. 2 is a flow diagram schematically describing a method of preparing a cathode active material for a lithium secondary battery in accordance with exemplary embodiments.

Referring to FIG. 2, a mixture of metal hydroxide particles and a lithium source may be prepared (e.g., in a phase of S10).

In exemplary embodiments, a reaction solution (e.g., an aqueous solution) including a metal salt, a chelating agent and a coprecipitation agent may be prepared. The metal hydroxide particles may be prepared by performing a coprecipitation reaction in the reaction solution.

In some embodiments, the metal salt may include a metal acetate, a metal sulfate, a metal nitrate, a metal hydroxide, a metal carbonate, a hydrate thereof, etc. The metal salt may include Ni, Co, Mn, Al, Zr, Ti, Cr, B, Mg, Mn, Ba, Si, Y, W, Sr, etc.

In some embodiments, the metal salt may contain nickel. The metal salt may further contain cobalt, manganese, aluminum, etc.

For example, a plurality types of the metal salts may be prepared so that the lithium metal oxide particles satisfy the composition (components and molar ratios of the components) of Chemical Formula 1 above.

For example, the co-precipitating agent may include sodium hydroxide, sodium carbonate, etc. For example, the chelating agent may include aqueous ammonia, ammonium carbonate, etc.

A temperature of the co-precipitation reaction may be appropriately adjusted according to common technical knowledge in the related art.

The lithium source may include lithium hydroxide, lithium carbonate, lithium nitrate, lithium acetate, lithium oxide, etc.

The mixture may be calcined to form lithium metal oxide particles.

In an embodiment, the calcination may be performed for 8 hours to 30 hours, hours to 25 hours, or 12 hours to 20 hours.

According to embodiments of the present invention, the calcination may include two or more calcination sections for firing the mixture while maintaining a predetermined temperature for a predetermined time.

The calcination of the mixture may include a first calcination performed at a first temperature (e.g., in a phase of S20), and a second calcination performed at a second temperature lower than the first temperature for the mixture after the first calcination (e.g., in a phase of S30).

For example, the first temperature may include a temperature at which the single particle-shaped lithium metal oxide particles may be formed, and the single particle-shaped lithium metal oxide particles may be formed by the first calcination.

In an embodiment, the first temperature may be in a range from 900° C. to 1000° C.

In an embodiment, the second temperature may be in a range from 600° C. to 800° C.

In some embodiments, the first calcination may include firing while maintaining a temperature range of ±20° C. (preferably ±15° C., more preferably ±10° C.) from the first temperature for a predetermined time.

For example, the first calcination may be performed for 1 hour or more, 1 hour to 10 hours, 1 hour to 8 hours, 1 hour to 6 hours, 1 hour to 5 hours, or 1 hour to 3 hours.

In some embodiments, the second calcination may include firing while maintaining a temperature range of ±20° C. (preferably ±15° C., more preferably ±10° C.) from the second temperature for a predetermined time.

For example, the second calcination may be performed for 1 hour or more, 1 hour to 10 hours, 1 hour to 8 hours, 1 hour to 6 hours, 1 hour to 5 hours, or 1 hour to 3 hours.

A generation degree of crystal nuclei and a growth of crystals in the lithium metal oxide particles may be controlled by the first calcination and the second calcination. Accordingly, an average value of crystal sizes of single crystals included in the lithium metal oxide particles may be adjusted within a predetermined range.

For example, when the lithium metal oxide particles are analyzed by the FIB so that 50 or more, 100 or more, 300 or more, or 500 or more particle cross-sections are measured, an average crystal size of the single crystals (provided that single crystals having the major axis length or the minor axis length of less than 0.3 μm are excluded) may be in a range from 1 μm to 3 μm, from 1 μm to 2.5 μm, from 1 μm to 2 μm, from 1 μm to 1.6 μm, from 1 μm to 1.5 μm, from 1.1 μm to 1.5 μm, or from 1.2 μm to 1.5 μm.

When only the second calcination is performed, the single particle-shaped lithium metal oxide particles may not be formed or may be formed in an excessively small amount. Further, when only the first calcination is performed, the average crystal size of the single crystals included in the lithium metal oxide particles may not satisfy the above numerical range.

In an embodiment, the first calcination and the second calcination may be alternately and repeatedly performed. For example, the first calcination, the second calcination and the first calcination may be sequentially performed.

In an embodiment, when performing the first calcination and the second calcination once each is defined as a calcination cycle, the calcination cycle may be performed at least twice. In this case, the average crystal size of the single crystals may be more easily adjusted within the above-described numerical range.

In some embodiments, the first calcination and the second calcination may be alternately and repeatedly performed. In this case, a total calcination time may be from 8 hours to 30 hours, from 10 hours to 25 hours, or from 12 hours to 20 hours.

In an embodiment, a heating rate to the first temperature for the first calcination may be from 1° C./min to 5° C./min. In an embodiment, a cooling rate from the first temperature to the second temperature for the second calcination may be 1° C./min to 5° C./min.

For example, a cathode slurry may be prepared by dispersing the lithium metal oxide particles prepared by the first calcination and the second calcination in a dispersion medium. The cathode slurry may further include the conductive material, the binder, etc.

The cathode slurry may be coated on the cathode current collector 105, and then dried and presses to form the cathode active material layer 110 satisfying Equation 1.

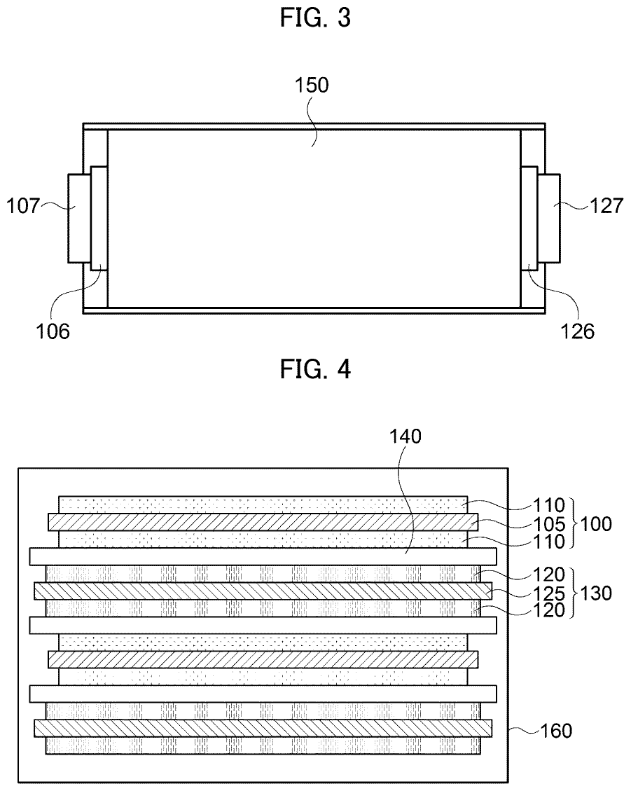

FIGS. 3 and 4 are a schematic plan projection view and a cross-sectional view, respectively, illustrating a lithium secondary battery in accordance with exemplary embodiments.

Referring to FIGS. 3 and 4, a lithium secondary battery includes a cathode 100 and an anode 130 facing the cathode 100.

The cathode 100 may be the above-described cathode for a lithium secondary battery.

The anode 130 may include an anode current collector 125 and an anode active material layer 120 formed on the anode current collector 125. For example, the anode active material layer 120 may be formed on one surface or both surfaces of the anode current collector 125.

The anode active material layer 120 may include an anode active material capable of reversibly intercalating and de-intercalating lithium ions. The anode active material layer 120 may further include a binder, a conductive material, etc.

For example, an anode slurry may be prepared by dispersing the anode active material, the binder, and the conductive material in a dispersion medium. The anode slurry may be coated on the anode current collector 125, and then dried and pressed to form the anode.

For example, the anode current collector 125 may include gold, stainless steel, nickel, aluminum, titanium, copper, or an alloy thereof.

The anode active material may include a lithium alloy, a carbon-based active material, a silicon-based active material, etc. These may be used alone or in a combination thereof.

For example, the lithium alloy may further include aluminum, zinc, bismuth, cadmium, antimony, silicon, lead, tin, gallium, indium, etc.

For example, the carbon-based active material may include a crystalline carbon, an amorphous carbon, a carbon composite, a carbon fiber, etc.

For example, the amorphous carbon may include, e.g., a hard carbon, coke, a mesocarbon microbead (MCMB), a mesophase pitch-based carbon fiber (MPCF), etc. The crystalline carbon may include, e.g., artificial graphite, natural graphite, graphitized coke, graphitized MCMB, graphitized MPCF, etc.

In an embodiment, the anode active material may include the silicon-based active material. The silicon-based active material may include, e.g., Si, SiOₓ(0<x<2), Si/C, SiO/C, Si-metal, etc. In this case, the lithium secondary battery having a high capacity may be implemented.

In some embodiments, an area of the anode 130 may be greater than that of the cathode 100. Accordingly, lithium ions generated from the cathode 100 may be easily transferred to the anode 130 without being precipitated.

For example, the cathode 100 and the anode 130 may be alternately and repeatedly disposed to form an electrode assembly 150.

A separation layer 140 may be interposed between the cathode 100 and the anode 130. For example, the electrode assembly 150 may be formed by winding, stacking or zigzag folding (z-folding) of the separation layer 140.

For example, the separation layer 140 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, etc. The separation layer 140 may also include a non-woven fabric formed from a glass fiber with a high melting point, a polyethylene terephthalate fiber, etc.

The lithium secondary battery according to exemplary embodiments may include a cathode lead 107 connected to the cathode 100 to protrude to an outside of a case 160, and an anode lead 127 connected to the anode 130 to protrude to the outside of the case 160.

For example, the cathode lead 107 may be electrically connected to the cathode current collector 105. The anode lead 127 may be electrically connected to the anode current collector 125.

The cathode current collector 105 may include a cathode tab 106 at one side thereof. The cathode active material layer 110 may not be formed on the cathode tab 106. The cathode tab 106 may be integral with the cathode current collector 105 or may be connected to the cathode current collector 105 by, e.g., welding. The cathode current collector 105 and the cathode lead 107 may be electrically connected via the cathode tab 106.

The anode current collector 125 may include an anode tab 126 at one side thereof. The anode active material layer 120 may not be formed on the anode tab 126. The anode tab 126 may be integral with the anode current collector 125 or may be connected to the anode current collector 125 by, e.g., welding. The anode electrode current collector 125 and the anode lead 127 may be electrically connected via the anode tab 126.

The electrode assembly 150 may include a plurality of the cathodes and a plurality of the anodes. Each of the plurality of the cathodes may include the cathode tab. Each of the plurality of the anodes may include the anode tab.

For example, the cathode tabs (or the anode tabs) may be laminated, pressed and welded to form a cathode tab stack (or an anode tab stack). The cathode tab stack may be electrically connected to the cathode lead 107. The anode tab stack may be electrically connected to the anode lead 127.

The lithium secondary battery may be fabricated into a cylindrical shape using a can, a prismatic shape, a pouch shape, a coin shape, etc.

The electrode assembly 150 may be accommodated together with an electrolyte in the case 160 to form the lithium secondary battery. For example, the electrolyte may include a lithium salt and an organic solvent.

The lithium salt may be represented by Li⁺X⁻. For example, the anion X⁻ may be any one selected from F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻.

For example, the lithium salt may include LiBF₄, LiPF₆, etc.

For example, the organic solvent may include a carbonate-based solvent, an ester-based solvent, an ether-based solvent, a ketone-based solvent, an alcohol-based solvent, an aprotic solvent, and the like.

The carbonate-based solvent may include, e.g., dimethyl carbonate (DMC), ethyl methyl carbonate (EMC), diethyl carbonate (DEC), ethylene carbonate (EC), etc.

The ester-based solvent may include, e.g., methyl propionate, ethyl propionate, propyl acetate, butyl acetate, ethyl acetate, butyrolactone, caprolactone, valerolactone, etc.

The ether-based solvent may include, e.g., dibutyl ether, tetraethylene glycol dimethyl ether (TEGDME), diethylene glycol dimethyl ether (DEGDME), dimethoxyethane, tetrahydrofuran (THF), 2-methyltetrahydrofuran, etc.

The ketone-based solvent may include, e.g., cyclohexanone.

The alcohol-based solvent may include, e.g., ethyl alcohol, isopropyl alcohol, etc.

The aprotic solvent may include, e.g., a nitrile-based solvent, an amide-based solvent (e.g., dimethylformamide), a dioxolane-based solvent (e.g., 1,3-dioxolane), a sulfolane-based solvent, etc.

### EXAMPLES AND COMPARATIVE EXAMPLES

### Example 1

(1) Preparation of Lithium Metal Oxide Particles

NiSO₄, CoSO₄ and MnSO₄ were added to distilled water from which dissolved oxygen was removed by a molar ratio of 80:10:10 to prepare a mixed solution. The mixed solution, NaOH (precipitating agent) and NH₄OH (chelating agent) were put into a reactor, and a co-precipitation was performed for 72 hours to prepare metal hydroxide particles (Ni_{0.8}Co_{0.1}Mn_{0.1}(OH)₂). The metal hydroxide particles were dried at 100° C. for 12 hours, and then re-dried at 120° C. for 12 hours.

A mixture was prepared by adding lithium hydroxide and the metal hydroxide particles to a dry high-speed mixer so that the molar ratio became 1:1.03.

The mixture was put into a calcination furnace, and the furnace was raised to 950° C. at a rate of 2° C./min, and a first calcination was performed while maintaining the temperature at 950° C. for 2 hours.

After the first calcination, a temperature of the calcination furnace was reduced to 800° C. at a rate of 2° C./min, and a second calcination was performed while maintaining the temperature at 800° C. for 2 hours.

The first calcination and the second calcination were repeatedly performed by two cycles (i.e., the first calcination, the second calcination, the first calcination and the second calcination were sequentially performed). The last second calcination was carried out for 9 hours.

During the first calcination and the second calcination, an oxygen gas was continuously supplied through the calcination furnace at a flow rate of 10 mL/min.

After the second calcination, the product was naturally cooled to room temperature, and then pulverized and classified to obtain lithium metal oxide particles (LiNi_{0.8}Co_{0.1}Mn_{0.1}O₂).

(2) Fabrication of Lithium Secondary Battery (Coin Half-Cell)

The lithium metal oxide particles as a cathode active material, carbon black as a conductive material and polyvinylidene fluoride (PVDF) as a binder were dispersed in N-methyl-2-pyrrolidone (NMP) by a weight ratio of 92:5:3, respectively to prepare a cathode slurry.

The cathode slurry was coated on an aluminum foil (thickness of 15 μm), and then dried and pressed to obtain a cathode. A lithium metal was used as a counter electrode (anode).

The cathode and the anode were each notched in a circular shape, and a circular polyethylene separator (thickness of 13 μm) was interposed between the cathode and the anode to prepare an electrode assembly.

The electrode assembly was placed in a coin-shaped casing and an electrolyte was injected to fabricate a coin-type lithium secondary battery. A 1M LiPF₆ dissolved in a mixed solvent of EC/EMC (30:70 v/v) was used as the electrolyte.

### Example 2

The first calcination and the second calcination were performed once each (however, the second firing was performed for 14 hours) to prepare lithium metal oxide particles.

A lithium secondary battery was manufactured by the same method as that in Example 1 using the lithium metal oxide particles.

### Comparative Example 1

A mixed solution was prepared by adding NiSO₄, CoSO₄ and MnSO₄ to distilled water from which dissolved oxygen was removed by a molar ratio of 80:10:10, respectively. The mixed solution, NaOH and NH₄OH were put into a reactor and co-precipitation was performed for 30 hours to prepare metal hydroxide particles (Ni_{0.8}Co_{0.1}Mn_{0.1}(OH)₂). The metal hydroxide particles were dried at 80° C. for 12 hours, and re-dried at 110° C. for 12 hours.

A mixture was prepared by adding lithium hydroxide and the metal hydroxide particles to a dry high-speed mixer so that the molar ratio became 1:1.03.

The mixture was put into a calcination furnace, and the furnace was raised to 700° C. at a rate of 2° C./min, and a first calcination was performed while maintaining the temperature at 700° C. for 15 hours. During the calcination, an oxygen gas was continuously supplied through the calcination furnace at a flow rate of 10 mL/min.

After the calcination, the product was naturally cooled to room temperature, and then pulverized and classified to obtain lithium metal oxide particles (LiNi_{0.8}Co_{0.1}Mn_{0.1}O₂).

A lithium secondary battery was manufactured by the same method as that in Example 1 using the lithium metal oxide particles.

### Comparative Example 2

A calcination was performed at 950° C. for 10 hours without being divided into the first calcination and the second calcination to prepare lithium metal oxide particles.

A lithium secondary battery was manufactured by the same method as that in Example 1 using the lithium metal oxide particles.

### Comparative Example 3

A calcination was performed was performed at 750° C. for 10 hours without being divided into the first calcination and the second calcination to prepare lithium metal oxide particles.

A lithium secondary battery was manufactured by the same method as that in Example 1 using the lithium metal oxide particles.

Experimental Example 1

(1) Crystal Size (S_{XRD}) Analysis

100 particles were randomly extracted and sampled from the lithium metal oxide particles of each of Examples and Comparative Examples. The sampled lithium metal oxide particles were analyzed by an XRD (X-ray diffraction) to measure a crystal size (S_{XRD}).

XRD analysis equipment and conditions are shown in Table 1 below.

TABLE 1
XRD(X-Ray Diffractometer) EMPYREAN

| Maker | PANalytical | |
|---|---|---|
| Anode material | Cu | |
| K-Alpha1 wavelength | 1.540598 | Å |
| Generator voltage | 45 | kV |
| Tube current | 40 | mA |

| | |
|---|---|
| Scan Range | 10~120° |
| Scan Step Size | 0.0065° |
| Divergence slit | ¼° |
| Antiscatter slit | ½° |

(2) XRD Spectrum Analysis

A ratio of a (110) plane peak and a (003) plane peak (hereinafter referred to as am XRD peak ratio) in the XRD analysis spectrum was measured according to Formula 2-1 below.

XRD peak ratio (%)=100×I(110)/{I(110)+I(003)} [Formula 2-1]

In Formula 2-1, I(110) is a maximum height of the (110) plane peak, and I(003) is a maximum height of the (003) plane peak.

### Experimental Example 2

(1) Morphology and Crystal Structure Analysis

Cross-sections of the cathode active material layer of the lithium secondary batteries of Examples and Comparative Examples were analyzed using a Scanning Electron Microscope (SEM) and a Focused Ion Beam (FIB).

In Examples 1 and 2 and Comparative Examples 2 and 3, lithium metal oxide particles having a shape of a single particle a polycrystalline structure and lithium metal oxide particles having a shape of a single particle and a single crystalline structure were mixed.

The lithium metal oxide particles of Comparative Example 1 had a shape of a secondary particle.

(2) Average Value (S_{FIB}) Analysis of Crystal Size of Single Crystals

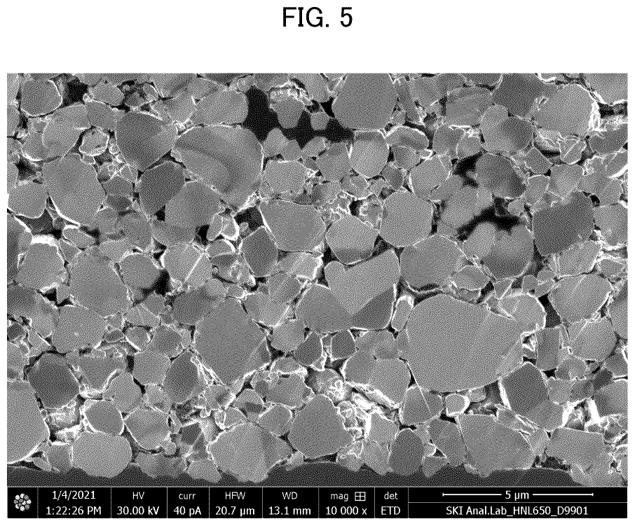

FIG. 5 is an image obtained by analyzing a cross-section of a cathode according to Example 1 using a focused ion beam (FIB).

In the FIB analysis image, an average value (S_{FIB}) of crystal sizes of single crystals was measured. FIB was measured according to Equation 1-1 below.

S_{FIB}=S/N [Formula 1-1]

In Formula 1-1, N is a total number of the single crystals in which at least one of a major axis length and a minor axis length was 0.3 μm or more measured from the FIB analysis image. S is a total sum of the crystal sizes of the single crystals in which at least one of the major axis length and the minor axis length was 0.3 μm or more measured from the FIB analysis image.

The crystal size of the single crystal means an average value of the major axis length and the minor axis length.

### Experimental Example 3

(1) Evaluation on Room Temperature Discharge Capacity

The lithium secondary batteries of Examples and Comparative Examples were repeatedly subjected to CC/CV charging (0.1C 4.3V, 0.05C CUT-OFF) and CC discharging (0.1C 3.0V CUT-OFF) at 25° C. twice, and a discharge capacity at the 2nd cycle Cl was measured.

(2) Evaluation on High-Temperature Life-span Property (Capacity Retention)

The lithium secondary batteries of Examples and Comparative Examples were CC/CV charged (1C 4.2V 0.05C CUT-OFF) and CC discharged (1C 2.7V CUT-OFF) at 45° C.

The charge and the discharge were repeatedly performed 400 times, and a discharge capacity C2 was measured at the 400th cycle was measured.

A high-temperature capacity retention was calculated according to the equation below.

High-Temperature Capacity Retention (%)=C2/C1×100(%)

(3) Evaluation on High-Temperature Storage Gas Generation

Lithium secondary batteries of Examples and Comparative Examples were CC/CV charged (1C 4.2V 0.1C CUT-OFF), and then stored in a constant temperature chamber at 60° C. for 8 weeks.

After the 8 weeks, each lithium secondary battery was placed in a vacuum sealed chamber equipped with a pressure gauge, and a hole was formed at a bottom of an exterior material of the lithium secondary battery. An amount of gas generation was calculated by measuring a pressure change in the chamber.

The results are shown in Tables 2 and 3.

TABLE 2

| | | | | XRD |
|---|---|---|---|---|
| | | | | peak |
| | | S_{XRD} | S_{FIB} | ratio |
| | lithium metal oxide particles | (nm) | (μm) | (%) |
| Example 1 | single particle & poly-crystalline + | 325 | 1.37 | 9.7 |
| | single particle & single crystalline | | | |
| Example 2 | single particle & poly-crystalline + | 340 | 1.66 | 9.3 |
| | single particle & single crystalline | | | |
| Comparative | secondary particle (poly-crystalline) | 130 | — | 10.1 |
| Example 1 | | | | |
| Comparative | single particle & poly-crystalline + | 256 | 0.94 | 9.8 |
| Example 2 | single particle & single crystalline | | | |
| Comparative | single particle & poly-crystalline + | 255 | 0.8 | 7.5 |
| Example 3 | single particle & single crystalline | | | |

TABLE 3

| | discharge | high temperature | high temperature |
|---|---|---|---|
| | capacity | capacity retention | gas generation |
| | (mAh) | (%) | (ml) |
| Example 1 | 212 | 88 | 21 |
| Example 2 | 210 | 86 | 27 |
| Comparative | 215 | 71 | 45 |
| Example 1 | | | |
| Comparative | 213 | 84 | 32 |
| Example 2 | | | |
| Comparative | 214 | 83 | 33 |
| Example 3 | | | |

Referring to Table 3, the lithium secondary batteries of Examples provided a high level of the discharge capacity and improved high-temperature stability compared to those from the lithium secondary batteries of Comparative Examples.

What is claimed is:

1. A cathode for a lithium secondary battery, comprising:
a cathode current collector; and
a cathode active material layer formed on the cathode current collector, the cathode active material layer comprising lithium metal oxide particles that have a single particle shape, and a single crystalline structure or a poly-crystalline structure including two or more single crystals,
wherein the cathode active material layer satisfies Formula 1:
1 μm≤S/N≤3 μm [Formula 1]
wherein, in Formula 1, N is a total number of single crystals in which at least one of a major axis length and a minor axis length is 0.3 μm or more in a focused ion beam (FIB) analysis image of the cathode active material layer,
S is a total sum of crystal sizes of the single crystals in which at least one of the major axis length and the minor axis length is 0.3 μm or more in the FIB analysis image, and
the crystal size of the single crystal means an average value of the major axis length and the minor axis length measured from the FIB analysis image.

2. The cathode for a lithium secondary battery according to claim 1, wherein 1 μm≤S/N≤2 μm.

3. The cathode for a lithium secondary battery according to claim 1, wherein, in the FIB analysis image, a ratio of a total cross-sectional area of the single crystals in which at least one of the major axis length and the minor axis length is 0.3 μm or more relative to a total cross-sectional area of the lithium metal oxide particles is 0.5 or more.

4. The cathode for a lithium secondary battery according to claim 1, wherein the lithium metal oxide particles comprise:
first lithium metal oxide particles having a shape of a single particle and a poly-crystalline structure; and
second lithium metal oxide particles having a shape of a single particle and a single crystalline structure.

5. The cathode for a lithium secondary battery according to claim 4, wherein, in the FIB analysis image, a ratio of the number of the second lithium metal oxide particles relative to the number of the first lithium metal oxide particles is in a range from 0.1 to 10.

6. The cathode for a lithium secondary battery according to claim 1, wherein the lithium metal oxide particles satisfy Formula 2:
9.8%≥100×I(110)/{I(110)+I(003)} [Formula 2]
wherein, in Formula 2, I(110) is a maximum height of a (110) plane peak in an X-ray diffraction (XRD) analysis spectrum measured for the lithium metal oxide particles, and I(003) is a maximum height of a (003) plane peak in the XRD analysis spectrum.

7. The cathode for a lithium secondary battery according to claim 1,
wherein the lithium metal oxide particles contain nickel (Ni).

8. The cathode for a lithium secondary battery according to claim 7, wherein Formula 3 is satisfied:
C≥140+0.738×Ni_{c} [Formula 3]
wherein, in Formula 3, C is a numerical value of a discharge capacity expressed in a unit of mAh/g measured by charging under constant current and constant voltage conditions of 0.1C 4.3V 0.05C CUT-OFF, and discharging under conditions of 0.1C 3V CUT-OFF of a half-cell having a lithium counter electrode, and
Ni_{c} is a numerical value of mol % of nickel relative to a total number of moles of all elements except lithium and oxygen in the lithium metal oxide particles.

9. A lithium secondary battery, comprising:
the cathode for a lithium secondary battery according to claim 1; and
an anode facing the cathode.

10. A method of preparing a cathode active material for a lithium secondary battery, comprising:
preparing a mixture of metal hydroxide particles and a lithium source;
performing a first calcination of the mixture at a first temperature; and
performing a second calcination of a product from the first calcination at a second temperature lower than the first temperature.

11. The method of claim 10, wherein the first calcination and the second calcination are each performed for 1 hour to 10 hours.

12. The method of claim 10, wherein the first temperature is in a range from 900° C. to 1000° C.

13. The method of claim 12, wherein the second temperature is in a range from 600° C. to 800° C.

14. The method of claim 10, wherein the first calcination and the second calcination are performed alternately and repeatedly.

15. The method according to claim 10, wherein at least two calcination cycles are performed, provided that performing the first calcination and the second calcination once each is defined as a calcination cycle.
